(19) United States
(12) Patent Application Publication
(10) Pub. No.: US 2005/0068938 A1
(43) Pub. Date: Mar. 31, 2005

(54) Internet Enhanced Cordless Telephone System

(75) Inventors: Tzyh-Jong Wang, Edison, NJ (US); Robert F Henrick, Basking Ridge, NJ (US); Michael P Skarzynski, Bernardsville, NJ (US)

Correspondence Address: TZYH-JONG WANG, 44 UTICA RD, EDISON, NJ, 08820, US

(73) Assignee: TELECOMMSOFT CORPORATION, Edison, NJ (US)

(21) Appl. No.: 10/605,397

(22) Filed: Sep. 28, 2003

(51) Int. Cl. H04L 12/66

(52) U.S. Cl. 370/352

(57) ABSTRACT

Disclosed invention is a consumer telephone system (the iCord telephone) that globally extends the range of cordless telephones by using the Internet to securely connect a cordless base station to multiple cordless handsets/phones. An iCord phone user can receive or make PSTN calls on the same iCord base station from anywhere that has Internet connectivity for one's iCord handset. The iCord system can page and carry on a VoIP conversation with any iCord handset registered on the same iCord base station without incurring PSTN telephone call charge. In addition, an iCord handset can simultaneously register and securely connect with multiple iCord base stations over the Internet. Thus an iCord handset user, from anywhere over the Internet, can receive or make PSTN phone calls from, for example, either office, home or friend's iCord base stations with the same iCord handset. Multiple iCord base stations can also set up as a private phone network over the Internet. Such that an iCord handset only needs to register with one iCord base station and can access any other base stations within the same private network. The iCord phone invention is also applicable to VoIP service that supports the use of cordless phones to receive or make VoIP calls.

### BACKGROUND OF INVENTION

The present invention, the iCord telephone system, is in the fields of Internet and Telephony integration and Customer Premises Equipment. The key idea is to use the Internet connectivity as the “cord” between the cordless telephone phone handset and the base station. The iCord telephone system improves the accessibility of the PSTN (Public Switched Telephone Network) service.

We first review the prior state-of-the-art regarding the access and use of the PSTN service with corded and cordless telephones. We also review telephony technologies, such as the cellular/mobile and the VoIP (Voice over IP) phone services, that intend to replace or compete with the PSTN service by offering a better service accessibility. We then illustrate how the iCord telephone system invention can utilize the VoIP technology to globally extend the range of a corded or cordless phone and thus enhance the access and use of the PSTN service.

What is the PSTN service from a subscriber's view? A sub-scriber contacts the telephone company to subscribe the PSTN service. The telephone company sends a technician to connect a telephone line from the nearby telephone pole to a wall jack at the subscriber's premises (home or office). The subscriber buys a telephone to connect to the wall jack and starts to use the phone to make or receive PSTN calls after the telephone company activated the service. This is the most accustomed form of telephony service as we know today.

For the first 100 years, since Alexander Graham Bell invented the telephone in 1876, the telephone service has been a stationary one. One had to go to the telephone to make phone calls. If one was on the road, then one could not access the telephone until one returned to the vicinity of the telephone. When there was an incoming call, the telephone rang to signal the call and people went to the telephone to pick up the call. If one was not within the audible distance when a call comes in, the call was either missed or handled by an answering machine. To meet the need to use telephone for real time communication, most people ended up having to access one or more telephones at each different locations, such as home, office or payphones when on the road.

Using multiple PSTN phones for business and personal communication is difficult to manage. One has to give out multiple phone numbers to customers, colleagues and friends. When calling a person with multiple accessible phone numbers, one has to decide which number to call to have a better chance to reach the person. Multiple calls to different phones might have to be tried while needing to converse immediately. Even that, the calls might all be missed or sent to an answering machine. Over the years, many solutions has be offered to consumers such as find-me/follow-me, personal 800 or call forwarding services. All of these services require the PSTN carrier to invest in infrastructure enhancement and impose additional subscription premium on subscribers.

Cordless telephones were introduced at around 1980. Its main contribution was to extend the accessibility of the PSTN service in the home/office while away from the telephone set. A cordless telephone consists of one or more handsets and a base station. The base station is still stationary. However, the cord between the handset and base station is replaced by a wireless/radio connection, thus comes the name “cordless”. A PSTN subscriber can carry a cordless handset and make/receive calls using the handset as long as one is within the radio range of the base station. Currently, with 900 mW (milli-watt) power and minimal barrier, the range of a cordless phone can be as far as 8 miles. However, most cordless phones operate at 1 to 10 mW and have a much shorter range of a few hundreds feet. Still a cordless telephone makes the PSTN service greatly more accessible than a corded telephone.

The next evolution for cordless phone was to allow a handset to “roam” beyond the range of its base station and continue to access the PSTN service. One approach is to set up public base stations for the cordless handsets to access the PSTN when out of range with its own base station. Systems supporting such are the Personal Handy Phone developed in Japan and the DECT (Digital Enhanced Cordless Telecommunications) in Europe. However, such roam-able cordless service is no longer as simple as just buying a cordless phone. Rather, the user has to find a location where the PSTN service provider had deployed public base stations. Also a roaming DECT or PHS handset no longer has any “cordless” connection with the home/office base station and becoming more like a cellular/mobile phone instead. Again, a PSTN subscriber must pay additional monthly premium to the PSTN carrier for the enhanced service.

An almost parallel evolution was the cellular/mobile phone systems developed in the early 1970 although did not become ubiquitous until the 1990s. Cellular/mobile phone service subscribers each uses a handset to access shared base stations operated by the mobile phone service providers. The system was originally balky and expensive and the infrastructure could not provide enough capacity. Over the years, the mobile phone system has reached sophistication. Handsets are much more compact. Service charge is reduced. Network capacity increased and voice quality improved. The GSM system is widely available in Europe, Asia and part of the United States. The CDMA and TDMA systems are popular in the United States. The advantage of modern days mobile/cellular phone is compact and wide coverage. A service subscriber with the mobile phone is reachable anywhere in the world's metropolitan areas and major rural areas. With the low cost of incremental minutes and unlimited night-and-weekend minutes that comes with the present day cell phone service plan, one can do without the PSTN phone service.

A mobile phone subscriber pays an extra premium to mobile phone carrier for reach-ability and accessibility on a separate bill. As of 2003, the cell phone service charges 10 to 50 cents per minute. Mobile phone service applies per-minute charge on both outgoing and, in the US, in-coming calls. Multiple subscriptions of mobile phone and service are needed for each member of a family. On the comparison, the PSTN service is free of per-minute charge when receiving calls and is also free of charge in most US areas when calling within the local area (IntraLATA, or Intra Local Access and Transport Area). Further, many households utilize multiple cordless handsets which allow in house and yard paging without any charge. As of 2003, the PSTN InterLATA and long distance call charge can be as low as 2 to 4 cents per minute.

During the time from the introduction of the cordless phone to today, a second communication network, the Internet, has become ubiquitous at homes, businesses and public places. The Internet is a packet oriented data network; as a contrast, the PSTN is a circuit oriented voice network. The Internet consists of a set of inter-connected backbone networks operated by major telecommunication carriers in each country. For example, the US Internet backbone is operated by AT&T, UUNET, WorldCom, Sprint, Qwest, Level 3, and many others. The backbone networks then connect to many access networks operated by Internet Service Providers (ISP). ISPs provide dial-up and broadband Internet access services to individual subscribers. Any two Internet access terminals (e. g., computers with modem) can communicate with each other no matter where the two terminals are located globally. This is very similar to the current day PSTN service: Any two PSTN phones can communicate with each no matter where the two phones are located globally.

The Internet has introduced new or enhanced forms for people to communicate. Two examples are e-mail and Instant Messaging. People can send electronic mails (e-mail) to each other instead of postal mails. The e-mails are transported across the Internet to the receivers' electronic mailbox. One can retrieve e-mails from own mailbox from anywhere globally using any Internet terminal with a mail tool such as Outlook or a browser such as Internet Explorer. The e-mail application is an asynchronous communication mechanism that the two communicating parties do not have to be on-line at the same time. As a contrast, Instant Messaging (IM) is a synchronous communication mechanism that two or more communicating parties have to be on-line at the same time to communicate. The IM text chat is provided through public or private “chat rooms”. One can connect to one or more chat rooms from anywhere globally using any Internet terminal with an IM tool such as AOL IM or a browser such as Internet Explorer.

The Internet, in addition to supporting text communication applications such as e-mail and IM, also supports voice communication application known as VoIP (Voice over Internet Protocol). Like IM, VoIP is a synchronous communication application. The two communicating parties must each be online using an Internet terminal (e.g., computer or VoIP phone) with VoIP software such as Net-Meeting or Net2Phone. The voice is digitized and packetized at either terminal which sends voice packets across the Internet to the other terminal to reproduce the voice and play it out.

The first VoIP application, Internet Phone software, was developed by Vocal Tec in February 1995. During its humble beginning, the voice quality was limited by low band-width across the Internet, half-duplex low grade sound card, slow CPU speed. Much has changed since then. The extended build out of optical core network and the fast introduction of broadband Internet access such as DSL and Cable Modems have relieved the bandwidth bottle-neck. Low-end PCs are now easily equipped with full-duplex sound cards and CPU speed at the neighborhood of 2 GHz. Although, QoS (Quality of Service) standards implementation is still scattered, VoIP can deliver toll quality voice with properly equipped computers, when the network is not too congested. Such form of communication is “free” in the sense of no per minute telephony charge. However, one can not make calls to any PSTN phone from a VoIP terminal; nor can one receive calls from any PSTN phone to a VoIP terminal.

The ITSPs (Internet Telephony Service Providers) such as Net2Phone and VONAGE have enhanced the VoIP service to allow a subscriber with a VoIP device to place and receive calls to and from any PSTN serviced telephones for a separate subscription service. Such enhancement is by installing PSTN/VoIP gateways inside the ITSP's network. ITSPs only charge their subscribers for outgoing calls through the PSTN gateway. Calls between two VoIP service subscribers remain free, except that most ITSPs require the two calling parties to subscribe from the same ITSP for obvious business reason. The ITSPs also provide specialized Internet Phone hardware such as VoIP phone or adaptor that offers the same accessibility as PSTN service. A VoIP subscriber plugs a VoIP phone to a network interface that connects to the Internet. Such VoIP phone has almost the same look and feel of a PSTN phone (corded or cordless). Alternatively, there are VoIP adaptors that allow a PSTN phone to hook up and make/receive VoIP calls. However, all of these forms of VoIP services, like cellular phone services, require the user to subscribe to a new service and pay a new bill on top of one's Internet access subscription.

The enhanced VoIP service offered by ITSPs has a better accessibility than the PSTN service. For example, a Net2Phone subscriber can make phone calls with one's laptop computer from anywhere with Internet access. A VONAGE subscriber can take and plug one's Cisco ATA-186 VoIP adaptor anywhere with Internet access and make/receive phone calls.

Many people these days are paying for multiple subscriptions for PSTN, Cellular and VoIP to get enhanced accessibility of their voice communication. In addition to that, most of these people are also paying Internet subscriptions for data communication. Of all these, the PSTN service has the least accessibility, limited by the radio range of cordless phones. There is a growing trend that subscribers cancel their PSTN service and use only the cellular phone service for reason of not want to “pay for the same service multiple times”. There are also people who replace their PSTN services with the ITSP's enhanced VoIP services for the same reason.

The inventors of the iCord telephone are motivated to extend the accessibility of PSTN service to well beyond the cordless range by taking advantage of the ubiquities of the Internet and the ease to set up a “free” VoIP path between two Internet appliances (i.e., the iCord handset and the iCord base station). The idea is summarize in the section follows.

### SUMMARY OF INVENTION

This invention (the iCord telephone system) extends the range and accessibility of a cordless phone by using the Internet in a manner analogous to and in addition to the cordless link. An iCord handset securely connects end-to-end to an iCord base station through the Internet, thus the name “iCord”.

The iCord phone system consists of a base station, one or more remote cradles and one or more cordless or corded phones/handset that can be used with either a base station or a cradle.

The iCord base station has three main interfaces to the PSTN, Internet and local cordless handsets, respectively. The iCord cradle has two main interfaces to the Internet and local cordless handsets, respectively. The cradle is a mediation device between the handsets and base stations. The handset connects cordlessly to a nearby iCord base station; or connects cordlessly to a nearby iCord cradle and through which to a remote iCord base station over the Internet. The handset can also connect directly to the base station over the Internet. The iCord telephone system has a range across the whole Internet rather than limited by cordless radio link.

In the principal embodiment of the invention, the iCord base station connects to the PSTN. The preferred connection is to a FXS RJ 11 (Foreign exchange Subscriber Registered Jack 11) wall socket, through the local copper loop and terminates at the CO (Central Office) of a PSTN service provider. The iCord base station connects to the Internet through a LAN (Local Area Network) or WLAN (Wireless LAN) interface. The preferred LAN access technology is, but not limited to, the IEEE 802.3 Ethernet family of standards; The preferred WLAN access technology is, but not limited to, the IEEE 802.11 WiFi (Wireless Fidelity) family of standards such as 802.11a, 802.11b or 802.11g. Like many cordless phones on the market, each iCord base station can have one or more iCord handsets connected through local wireless connections. The preferred cordless standard is, but not limited to, the DECT standard. The iCord base station can also have a FXS RJ11 socket to plug a corded PSTN phone into and use.

An iCord wireless handset connects to the iCord base station by conventional cordless phone technology when in range. The preferred cordless standard is DECT. However, the implementation is open to any cordless standard, even proprietary ones. As with conventional cordless phones, each iCord handset can be authorized to communicate with the iCord base station by placing the iCord handset in the base station receptacle, making a physical contact to exchange security information as well as charging the iCord handset battery. Alternatively, an iCord handset authenticates with an iCord base station securely over the Internet and be authorized to communicate with the base station.

In the principal embodiment of the invention, each iCord handset can also be used with an iCord cradle. The preferred cordless connection between the handset and the cradle is based on, but not limited to, the DECT protocol. The iCord cradle is mainly an mediation device that bridge an Internet connection and an cordless/corded connection. The cradle has an Ethernet interface that can connect to a LAN and in turn connect to the Internet. The handset initiates a secured tunneled connection, through the cradle, across the Internet, with a base station and processes the authentication and authorization steps. The handset when not in use can use the cradle to recharge its battery. The iCord cradle can also have a FXS RJ11 socket to plug a corded PSTN phone into and use.

The Internet communication (i.e., the iCord connection) between an iCord handset and an iCord base station is, by design, protected by an authenticated, authorized and secured connection. The preferred protection standard is IPSec defined by the IETF (Internet Engineering Task Force). However, the implementation is open to use any security standard appropriate and even a proprietary protection mechanism if necessary. The only requirement is that the protection must be applicable to both TCP connections and UDP datagrams.

The iCord phone implements IPSec in the following way. Both the handset and the base station support an IPSec integrated IP layer within their TCP/UDP/IP stacks.

In order for an iCord handset to register with a base station over the Internet, the owner of the handset obtains an user id and a password from the owner of the base station. The base station has an access control database that stores all authorized users' ids, their passwords and access rights. Once obtained the user id and password, the handset owner sets the handset into an administration mode and starts the registration process. The handset first obtains the current IP address and public key of the base station from a DNS (Domain Name Service)/LDAP (Lightweight Directory Access Protocol) server and starts the IKE (Internet Key Exchange) session with the base station's registration port with either TCP or UDP. The public-key signatures, such as DSS (Digital Signature Standard) or RSA is used to establish the IKE SA (Security Association). After the IKE SA is created, the handset user is asked to input a user id and a password. The base station, after received the encrypted user name and password, confirms the validity of the handset user and proceeds to set up two IPSec SAs where one SA is readily used for IP packet protection and the other is a backup SA to be used once the first IPSec SA expires. Also, an IP address for the handset is assigned by the base station or a DHCP server on the base station's LAN. When the backup SA is in use after the main SA expires, IKE is used to created a new backup SA. The matching SAs on the handset is also established in the same way through the same IKE session.

The IPSec SA uses the ESP (Encapsulating Security Payload) in a tunneled mode to protect IP packets. With ESP in tunneled mode, all inside IP packets are encrypted. The tunnel is established end-to-end between the handset and the base station. Here we have expected all nodes on the communication path supports IPSec-over-NAT (Network Address Translation) or IPSec-pass-through.

To handle the case that an iCord base station's IP address is dynamically assigned by a DHCP server, a trusted “Dynamic DNS” server can be provided to iCord phone owners. In most of the current home and SOHO (Small Office Home Office) networking setting, an iCord base station is likely operating behind the NAT service of an Internet sharing gateway. The gateway's IP address is dynamically assigned by the ISP's DHCP. Incoming handset connections to an iCord base station can be done by port-forwarding through the gateway's dynamic IP address which is subject to change upon “DHCP lease” renewal. An iCord base station can query the home/office gateway to check if the DHCP assigned IP address of the gateway has changed or not. If changed, the base station would contact the Dynamic DNS to update the new IP address.

Unlike any existing cordless phone, the iCord Phone also allows an iCord handset to securely simultaneously registers with more than one iCord base stations to receive and make calls from any of these base stations. Prior to this invention, no cordless handset can do this. The closest approximation is to receive calls from other phones through paid subscription of call forwarding or the rarely used and expensive follow-me/find-me service. To make an outgoing call, a handset with multiple base station registrations would prompt its user to select a base station to make the call. On the other hand, upon receiving an incoming call alerting, the handset would indicate which base station the incoming call is from.

An alternate embodiment of the iCord handset is to replace its cordless interface [0023] with a wireless LAN (WLAN) interface. This handset connects to a WLAN access point to access the Internet, through which to connect to an iCord base station over an end-to-end secure tunnel. The preferred WLAN standards are 802.11a, 802.11b, 802.11g or their future versions. Alternative to WLAN, the wireless PAN (Personal Area Network) such as Bluetooth, ZigBee or UWB (UltraWideBand) can be used in place of. A WLAN handset would not need to use the iCord cradle to connect to iCord base stations. It can be used in places where public WLAN is offered such as college campus or WiFi Hotspots.

Another alternative embodiment is to augment the iCord handset's cordless [0023] or WLAN [0031] interface with a wireless WAN (Wide Area Network) interface. The preferred wireless WAN standards would be 3G/UMTS or its future evolution such as 4G. This type of handset would use cordless or WLAN to access Internet when feasible and would switch to use wireless WAN if that is the only available access. Here we implicitly assume the wireless WAN would remains a more costly access that cordless and WLAN in the foreseeable future.

Yet another embodiment is to simply have a wired LAN interface on the iCord handset to replace the cordless [0023] or WLAN [0031] interface. This would make a “corded” iCord handset. The preferred LAN protocol is based on the IEEE 802.3 family of standards. This type of handset would be suitable as a desktop phone extension and is expect to be less costly than other embodiments due the wide availability of Ethernet LAN transceiver and MAC chip.

Still another embodiment is to emulate/implement an iCord handset by a PC (desktop, laptop or tablet, etc.) or PDA (Personal Digital Assistant) with built-in speaker and microphone. The “soft iCord handset” runs the iCord client software and uses the existing Ethernet LAN interface or 802.11a,b,g WLAN interface to access the Internet.

Similar to the embodiment of the soft iCord handset, an alternative embodiment of the iCord base station can be realized with a personal computer or a server computer that runs the iCord base station server software. The “soft iCord base station” uses its existing LAN interface or 802.11a,b,g wireless LAN interface to access the Internet; the soft base station uses a telephony card such as the ones by Dialogic to interface with the PSTN network. By a simple extension, multiple soft iCord base stations can be implemented by the same server computer. The server can be equipped with one or more high capacity PSTN interfaces such as, but not limit to, channelized T1/E1 or T3/E3; and one or more high capacity Internet connection such as, but not limit to, unchannelized T1/E1 or T3/E3. A service provider with one or more iCord servers can offer subscribed “virtual base station” service. Each user can subscribe and access own virtual base station the same way as accessing a CPE (Customer Premises Equipment) hardware base station. According to the economy of scale principle, the cost of provisioning for each iCord (virtual) base station user is expected to be less than the physical base station. Server-based iCord service is an effective solution for enterprise iCord solution for employee and for carrier to offer iCord service to the general public.

The call handling functionality of the iCord phone system is similar to that of any corded/cordless PSTN telephone. Upon an incoming PSTN call via the PSTN connection, the base station controller examines the memory for all the authenticated and authorized handsets that are connected via local cordless connections or via Internet to send the incoming call alert message. The base station can also use filter rules to select a subset of iCord handset to alert based on information such the caller ID. The base station can also run as an automated attendant that answer the incoming call with prerecorded voice greeting and present voice menu such as “press 1 for John; press 2 for Jane; . . . press 0 for everyone” and alert the selected iCord handsets based on caller's selection. The preferred implementation of the automated attendant function is based on, but not limited to, the VoiceXML standard. If no alerted handset pickup the call, the call is send to answering machine or simply dropped.

A user with an iCord handset can also make an outgoing call in a manner similar to one using a corded/cordless telephone. They first check for dial tone on the iCord handset and knowing that the iCord base station's PSTN interface is idle. The iCord user then enters the phone number. A call message together with the phone number to be called is sent to the base station either by the local cordless interface or through a local cordless interface to an iCord cradle which then forward the message to the iCord base station via the Internet. The base station then places a PSTN outgoing call based on the given phone number. For an iCord handset connecting to multiple iCord base stations, the user can also query for availability and select an idle base station to make the outgoing call.

An iCord phone can also page another iCord phone and make a voice call in a matter similar to the use of multiple cordless handsets. Each phone registered can be assigned a designator, such as “Mom's” or “Dad's” through the DTMF keyboard or a PC. Through either speed-dial numbers or a one line text interfaces, each handset can select a name from the directory and call that person's iCord handset. This directory may also include PSTN entries such as “Mom's cell”. If both cordless handsets are cordlessly connected to the same base station, the paging connection is local wireless in a manner identical to conventional cordless phone system. If at least one handset connects to the base station through the Internet, a VOIP connection is used between the two paging handsets is used. A similar procedure can be used to page and add a third iCord user to a call in progress.

When an iCord handset has registered with multiple iCord base stations and is authorized to make outgoing PSTN calls from these base stations, the handset can query the base stations for estimation of the cost of a PSTN call or other selection criteria such as best QoS (Quality of Service) Internet connection. The handset user can then decide which base station to use for the outgoing call. The choice does not have to be the least cost one and the user can have the ultimate choice. This feature allows multiple private or business iCord phone systems owners to form a private network to support both iCord phone to iCord phone VoIP calls or to make local calls across state or national boundaries. To simplify the administration process of handset registration with multiple base stations, a set of base stations can form a “trusted” private network that a handset registered with one member base station would automatically registered with all member base stations and gains access authorizations.

An iCord handset can also register with a Service Provider's public virtual iCord base stations which can provide additional PSTN services such as pay-per-use or pre-paid calls. In this manner the iCord user has the option of taking advantage of existing VoIP commercial services.

### BRIEF DESCRIPTION OF DRAWINGS

The drawings illustrate the design and utility of preferred embodiments of the present invention, in which similar elements are referred to with common reference numerals:

FIG. 1 is an illustration of the main components of the invention;

FIG. 2 is a schematic illustration of an embodiment of an iCord base station;

FIG. 3 is a schematic illustration of the preferred embodiment of an iCord handset and cradle;

FIG. 4 is a schematic illustration of an alternative embodiment of an iCord handset;

FIG. 5 is a schematic illustration of another WiFi wireless embodiment of an iCord handset;

FIG. 6 is an illustration of how an iCord handset, illustrated in FIG. 2, is connected to an iCord base station, illustrated in FIG. 1.

FIG. 7 is an illustration of how an iCord base station connects multiple iCord handsets to form an iCord phone system.

FIG. 8 is an illustration of how an iCord handset connects multiple iCord base stations to be part of multiple iCord phone networked systems.

FIG. 9 is a flowchart showing the processing of an PSTN incoming call of an iCord phone system, illustrated in FIG. 1.

FIG. 10 is a flowchart showing additional handsets paged into an PSTN incoming call illustrated in FIG. 9.

FIG. 11 is a flowchart showing the processing of an PSTN outgoing call of an iCord phone system, illustrated in FIG. 1.

FIG. 12 is a flowchart showing an iCord handset registered with two iCord base stations, and an VoIP provider offering commercial virtual iCord base station, service making an outgoing PSTN call.

### DETAILED DESCRIPTION

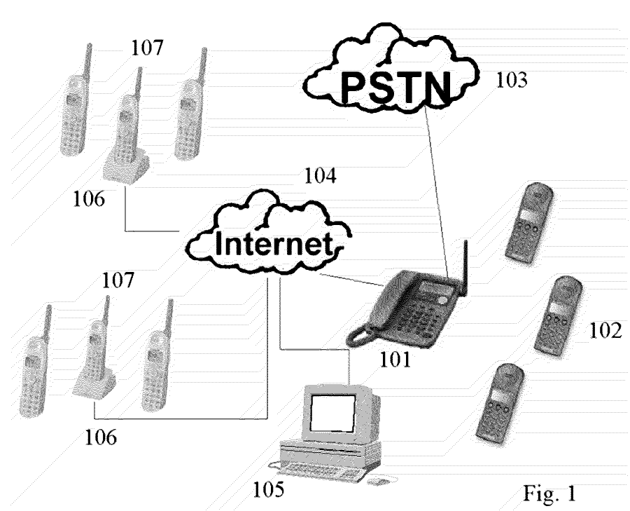

The components of the iCord invention are illustrated in FIG. 1. The iCord system consists of a base station [101] and one or more handsets [102, 107], one or more cradles [106]. The base station's management interface is handled by a built-in web server. The equipment owner can manage or configure the base station with a browser through a computer [105] over a local or wide area IP Internet connection [104]. The Internet connection is also used to provide connectivity from the base stations [101] to one or more handsets [107] through cradles [106]. Each handset [107] has an end-to-end secured connection (iCord connection) to the base station mediated by the cradle [106]. The base station [101] provides voice connectivity through the Public Switched Telephone Network (PSTN) [103] which provides voice communications from the iCord handsets [102, 107] to any wired, cordless or cellular telephone connected to the PSTN [103].

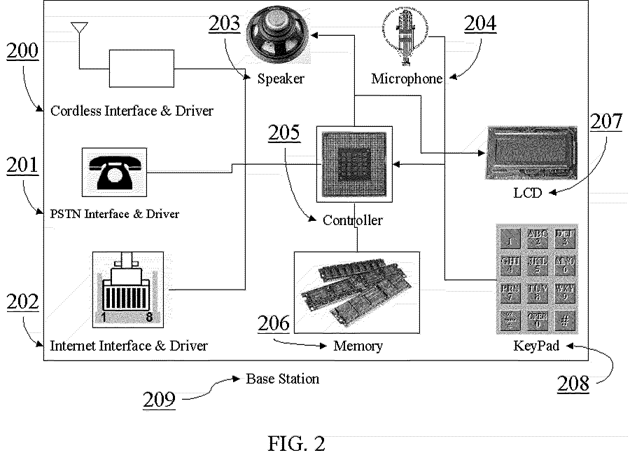

Embodiment with reference to FIG. 2, an iCord base station consists of cordless [200], PSTN [201] and Internet [202] interfaces and drivers. The cordless [200] interface and driver communicates with one or more nearby iCord handsets based on, but not limit to, the DECT cordless standard. The PSTN [201] interface and driver connect to the CO (Central Office) based on, but not limit to, the Loop-Start (FXO) network interface. The Internet [202] interface and driver connect to the Internet based on, but not limit to, the 100 Mbps Fast Ethernet interface. The controller [205] listens for and responds to events from the three interfaces [200, 201, 203]. The code and data needed by the controller is stored in a memory [206] that is based on, but not limit to, the SDRAM (Synchronous Dynamic Random Access Memory) memory technology.

The iCord base station also has an embedded speaker [203] and microphone [204] as well as a LCD display [207] and keypad [208] for use to make and receive PSTN phone calls and select stored addresses without need to have an iCord handset. The implementation can be in a form of a speaker-phone or a base station with a corded handset.

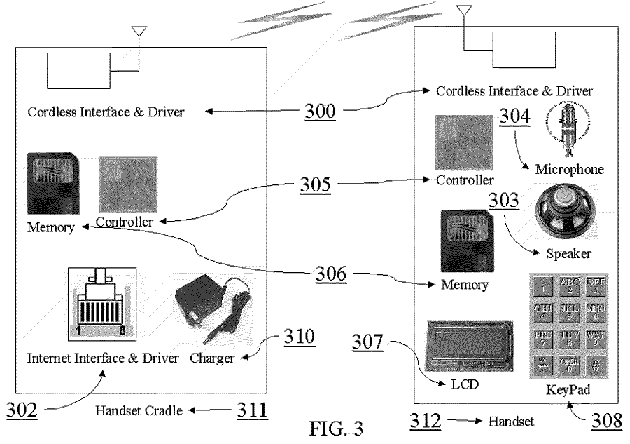

With reference to FIG. 3, an iCord handset consists of a cradle [311] and a handset [312]. The handset [312] normally rests in the cradle [311] to charge its battery (not shown in FIG. 1). The handset [312] consists of a cordless [300] interface and driver which is implemented based on, but not limited to, the DECT cordless standard. The handset [312] has speaker [303], microphone [304], LCD display [312] and keypad [308] for use to make and receive phone calls through the cordless connection with the cradle [311]. The controller [305] and the memory [306] is implemented based on but not limit to an 8-bit micro-controller and flash memory, which implements the call control and media handling logic of the handset. A LCD display [307] and keyboard [308] provide the ability to make and receive PSTN phone calls and select stored addresses.

The cradle [311] consists of a cordless [300] interface that serve as an access point of one or more cordless handsets [312]. The cradle [312] also has an Internet interface [302] that is based on but not limit to an 100 Mbps Fast Ethernet interface. The controller [305] (based on but not limit to 8-bit micro-controller) and the memory [306] (based on but not limit to flash memory) of the cradle [311] provide the mediation/bridging service for the control and media information between the cordless [300] and the Internet [302] interfaces. The controller only passes authorized information from authenticated iCord handsets to the iCord base stations.

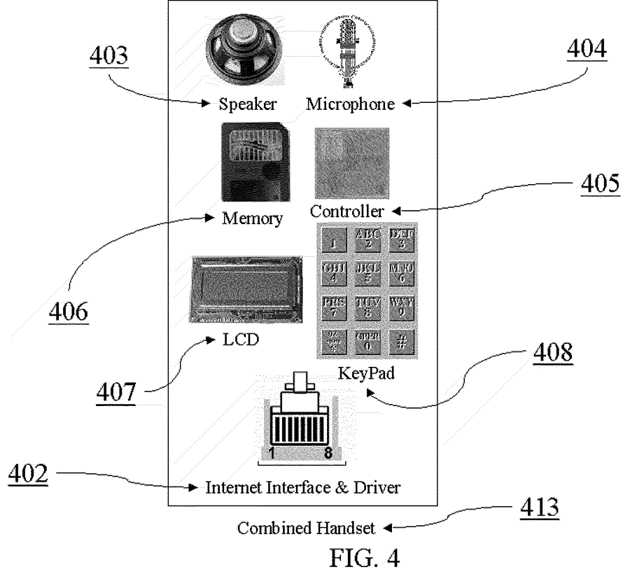

With reference to FIG. 4, an iCord handset [413] with a wired Internet connection [402] is described. This embodiment of the handset combines the previously described functionality and components of the iCord cordless handset [312] with the iCord cradle [311]. The handset [413] has speaker [403], microphone [404], LCD display [407] and keypad [408] for use to make and receive phone calls and select stored addresses through the cordless protocol over the LAN [402].

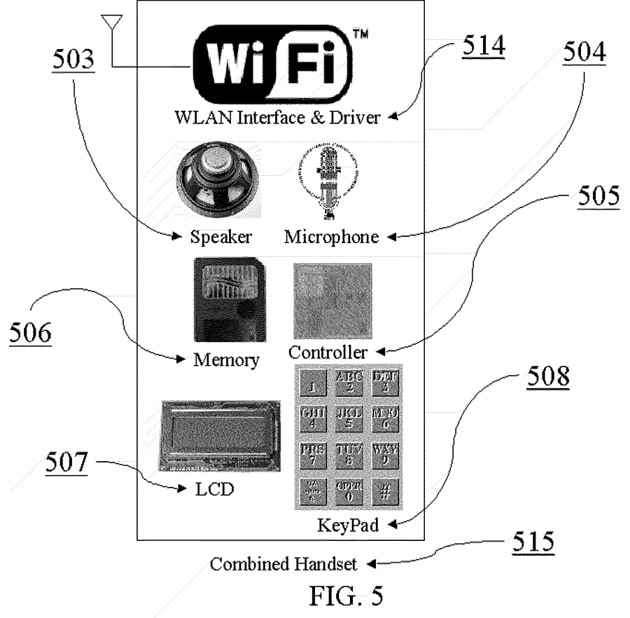

With reference to FIG. 5, an iCord handset [515] with a WLAN interface [514] is described. This embodiment of the handset substitutes the LAN interface [402] with a WLAN interface [514]. The handset [515] has speaker [503], microphone [504], LCD display [507] and keypad [508] for use to make and receive phone calls through the cordless protocol over the WLAN interface [514]. In the principal embodiment, this WLAN interface [514] implements the IEEE 802.11 WiFi set of standards and accesses the Internet with. In alternate embodiments, this can be extended to low latency wireless interfaces that include but are not limited to cellular 3G networks, Satellite connections and Personal Area Networks such as Bluetooth, ZigBee or UWB.

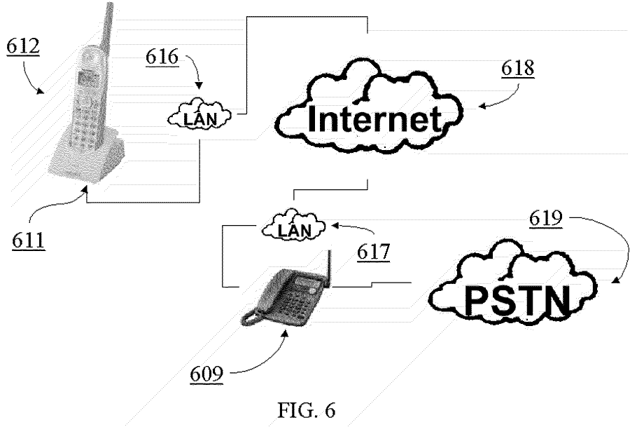

With reference to FIG. 6, the iCord connection path of an iCord handset, as described in FIG. 2, to an iCord base station is explained. The handset [612] implements the DECT protocol (DLC, MAC and PHY layers) and TCP/UDP/IP+IPSec on top of DECT to support the telephony application layer. The cradle [611] implements the DECT protocol (DLC, MAC and PHY) and the Ethernet protocol (IEEE 802.3) with a inter-working unit that translate between the DECT and Ethernet protocols. The base station [609] implements the Ethernet protocol (IEEE 802.3) and TCP/UDP/IP+IPSec to support the telephony application layer. The handset [612] and cradle [611] are on a LAN [616] with a own private IP address space and connects to the Internet [618] through a NAT gateway. The handset obtains a private IP address from the DHCP server on LAN [616]. The base station [609] is on a LAN [617] with a own private IP address space and connects to the Internet [618] through a NAT gateway. The NAT gateway forwards a number of ports to the base station for external connections from the handsets. The base station's NAT gateway's public IP address is published on a dynamic DNS

An iCord handset initiates the IPSec-protected TCP connection to the iCord base station for sending/receiving telephony control messages such as call initiation and call alert. The destination IP address of the base station is obtained by querying the dynamic DNS service. The TCP/IP packets are sent to the cradle [611] through the DECT DLC link and are mediated/forwarded by the cradle to the LAN [616] NAT gateway and to the Internet. The packets are received by the NAT gateway at LAN [617] which forwards the packet to the base station based on port-forwarding pre-configured. The reversed direction packets are forwarded to the handset by the NAT gateway at LAN [616] based on the TCP connection port forwarding table in the NAT database.

An iCord handset sends and receives IPSec-protected UDP datagrams to and from the iCord base station. The datagrams are used to transport voice packets. The UDP/IP packet are sent to the cradle [611] through the DECT DLC link and are mediated/forwarded by the cradle to the LAN [616] NAT gateway and to the Internet. The packets are received by the NAT gateway at LAN [617] which forwards the packet to the base station based on port-forwarding pre-configured. The reversed direction packets are forwarded to the handset by the NAT gateway at LAN [616] based on the UDP session port forwarding table in the NAT database. The NAT gateways on the LANs [616, 617] must support IPSec-over-NAT.

The firewall at the LAN [617], if present, must allow packets destined to the pre-configured ports into the LAN. Also, the firewall at the LAN [616], if present, must allow the dynamically allocated ports for TCP connections and UDP sessions.

In an alternate embodiment, if a firewall prevents the base station [609] from sending/receiving the message from the handset [612] then a intermediate server is used for “http spoofing” in a manner well known to those familiar with the art of instant messaging. The base station [609] registers with this server as does the handset [612] and then uses the server as the intermediary to communicate. The intermediate server can be either one provided by the manufacturer of the iCord system or a publicly available Instant Messaging server, such as that provided by AOL or Microsoft. In this embodiment, the server facilitates message communication between base station [609] and handset [612]. In such a firewalled environment, the base station [609] and/or handset [612] would use an open port on the firewall (say port 80) for exchange of VOIP voice traffic, in a manner well known to users of VOIP systems.

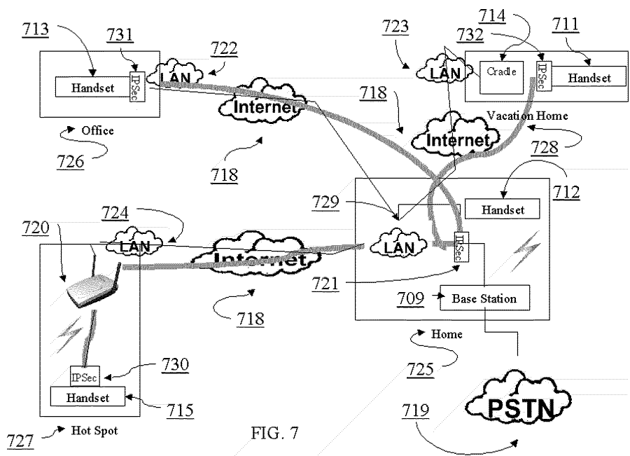

With reference to FIG. 7, an iCord base station [709] can have multiple iCord cradles and their associated handsets or WLAN/LAN capable handsets connected to it at the same or different times from anywhere globally on the Internet as well as from the local environment. In this illustration, an iCord base station [709] is at home [725]. An iCord handset [712], as illustrated in FIG. 2, at home [725] can connect to the base station [709] through a cordless connection.

A LAN-based iCord handset [713] in the office [726] can authenticate with the base station [709], establish an IPSec connection through the IPSec end point [731], office LAN [722], Internet [718], home LAN [729] and the IPSec end point [721] to exchange encrypted control messages and media stream during phone calls.

A WLAN-based iCord handset [715], as illustrated in FIG. 4, in a wireless LAN hotspot [727] can authenticate with the base station [709], establish a secured connection through the IPSec end point [730], wireless access point [720], HotSpot LAN [724], Internet [718], home LAN [729] and the IPSec end point [721] to exchange encrypted control messages and media stream during phone calls.

An iCord handset [711] and a cradle [714], as illustrated in FIG. 2, in a vacation home [728] can authenticate with the base station [709], establish a secure connection through the IPSec end point [732], vacation home LAN [723], Internet [718], home LAN [729] and IPSec end point [721] to exchange encrypted control messages and media stream during phone calls.

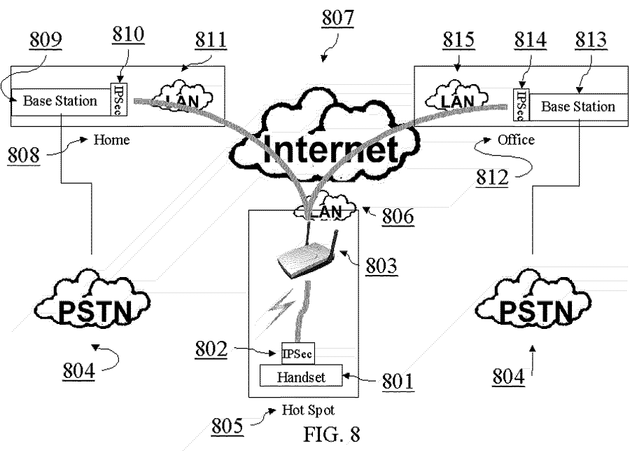

With reference to FIG. 8, an iCord handset [801] can, at the same time, establish authenticated connections with multiple iCord base stations from anywhere on the Internet. In this illustration, an iCord handset [801] is at a wireless LAN hotspot [805]. Upon entering the wireless LAN and detecting the presence of Internet connectivity, the WLAN-based handset [801] authenticates first with the iCord base station [809] at home [808]. The handset [801] then also authenticates with the iCord base station [813] at office [812]. Incoming calls to either the home [808] base station [809] or the office [812] base station [813] would alert the handset [801] with indication of which base station has the alerted incoming call on the display. The handset [801] can also select to place an outgoing call either through the home base station [809] or the office base station [813]. The handset would also have access to directories of other handsets registered with each base station for paging purposes. In this way, owners of base stations can allow their respective iCord phone users to form a private telephone network.

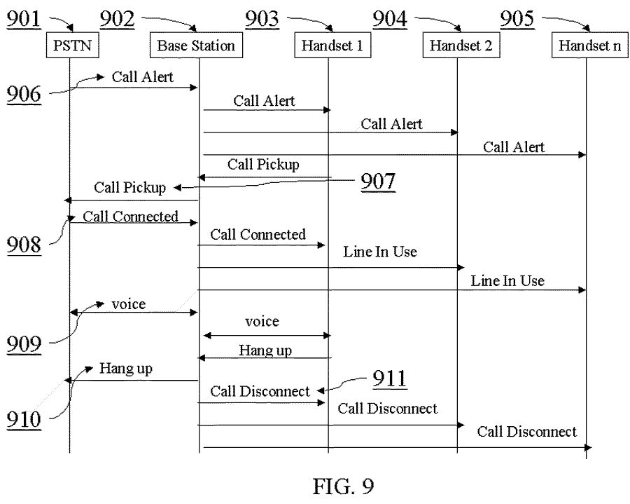

With reference to FIG. 9, the incoming call handling messaging of an iCord phone system is illustrated. Upon an incoming call, the PSTN [901] interface sends a Call Alert [906] message to its iCord base station [902] controller. The base station [902] broadcasts the Call Alert [906] message to all authenticated and authorized handsets [903, 904, and 905]. This message may be sent via the cordless interface for local handsets or via an TCP message to distant handsets. In the principal embodiment of the invention, all handsets are alerted, producing audible an alert sound. In an alternate embodiment of the invention, the base station [902] may be programmed via the web interface to use caller information such as caller ID to ring selective handsets. A user of handset [903] presses an key to accept the call. The handset [903] sends a Call Pickup [907] message back to the base station [902] which forwards the message to the PSTN interface [901]. The PSTN [901] interface picks up the call and establish the call path with the incoming caller. Packetized voice [909] is exchanged between the handset [903], the base station [902] and the PSTN interface [900]. The base station [902] also sends a message to other handsets to cease ringing and indicate PSTN line in use for this base station presented to the user by a visual indicator on the phone display. At the end of conversation, user of the handset [903] press a key to signal hanging up the call. The handset [903] sends a Hang Up message [910] to the base station [902] which forwards the message to the PSTN interface [901]. Also the base station [902] broadcast a Call Disconnected [911] message to all authenticated and authorized handsets who would indicate Line Available to their users through LCD display.

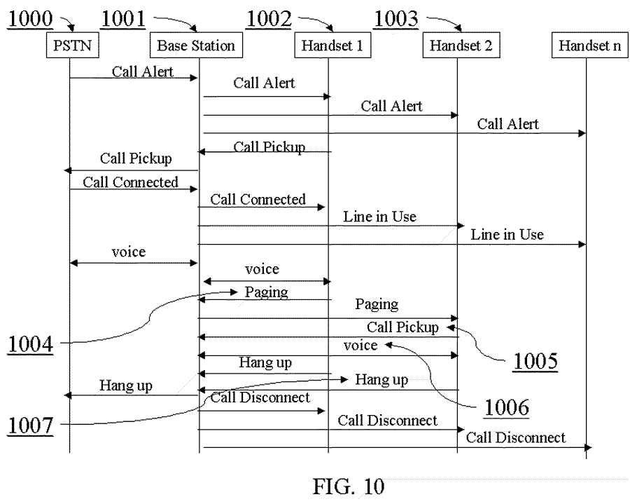

With reference to FIG. 10, during a call, additional handsets can be paged to join the call is illustrated. Here the illustration expands on the simple two party call of FIG. 9. After the handset [1002] is engaged in the call, the user presses a key to signal the intention to bring another handset [1003] to join the conversation. Each base station provides a list of users available to the handset and the user selects one. The handset [1002] sends a Page [1004] message to the base station [1001], which forwards the message to the selected handset [1003]. The handset [1003] alerts its user with audible sound. The user of handset [1003] presses a key to pick up the paging call and the handset [1003] sends a Call Pickup message to the base station [1001] and thus establishes a voice connection with the base station [1001] to join the multi-party conversation. The base station provides a mixing function for the two VOIP connections and the PSTN connection. At the end of conversation, handset [1002] hangs up [1007] and leaves handset [1003] in the conversation. Afterward, handset [1003] hangs up and the call is disconnected. If the PSTN party hangs up, both iCord users can continue in their paging call.

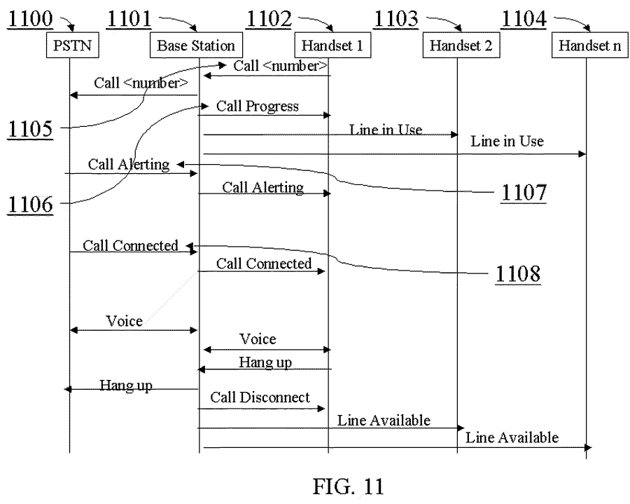

With reference to FIG. 11, the outgoing call handling messaging of an iCord phone system is illustrated. The user of handset [1102], after checked from the LCD display for availability of the PSTN interface, uses the keypad to punch in the number to be called or selects a number from a directory presented on the display and presses a key to signal the call intent. The handset [1102] sends the Call message [1105] with the number to be called to the base station [1101] which forward the message to the PSTN interface [1100]. The base station [1101] sends a Call Progress [1106] message to handset [1102]. The base station [1101] sends a Line in Use message to all authenticated and authorized handsets [1102, 1103 and 1104] which indicate this base station status on the visual display. Upon the PSTN sends alerting to both parties, the PSTN interface [1100] sends a Call Alert [1107] or call busy message to handset [1102] which plays a ringing or busy tone to the user [1102]. When the called party picks up the call and the PSTN service establishes the call path, the PSTN interface [1100] sends a Call Connected [1108] message to the base station [1101] which sends the message to the handset [1102]. The flow proceeds as in FIGS. 9 and 10.

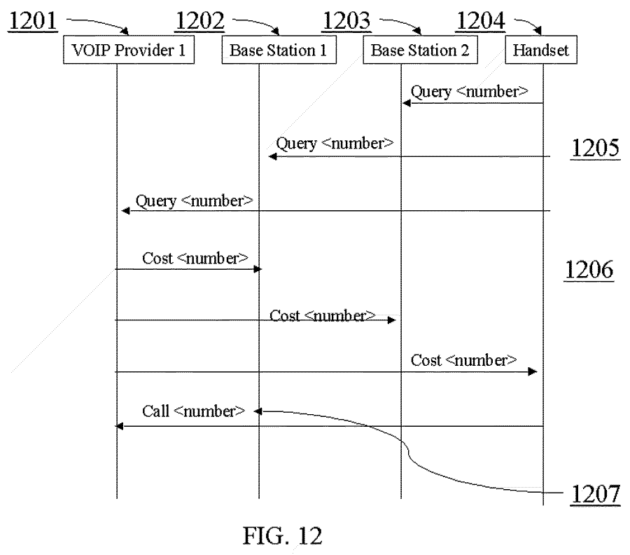

With reference to FIG. 12, an iCord handset can selectively use any of the base stations it is authenticated and authorized to make outgoing calls. In this illustration, the handset [1204] connects to a VoIP service provider's virtual base station [1201] and two base stations [1202 and 1203]. From the perspective of the handset, the protocol of connecting to a virtual base station is the same as other base stations. The user of the handset [1204] punch in the PSTN number to be called and press a key to query [1205] the estimated cost of making a 3-minute PSTN call from all base stations [1202 and 1203] and the VOIP provider [1201] with whom the user has established an account. Each base station sends back a Cost [1206] message to the handset [1204]. The handset user then decides to use one of the base stations [1202 and 1203], or the VOIP provider [1201] as illustrate in the Figure to place the out-going call.

1. We claim an iCord telehone system for making/receiving voice phone calls is comprised of
a. an iCord base station with internet, PSTN and cordless connectivity;
b. one or more iCord cradles with internet connectivity and cordless connectivity;
c. one or more iCord cordless handsets with cordless or internet (through LAN or WLAN) connectivity to the iCord base station directly or through cradles;
where the range of the iCord telephone system is extended globally over the internet by implementing end-to-end secured internet connectivity from the iCord handset to the iCord base station.

2. The iCord telephone system of claim 1, wherein said base station comprises of
a. a controller for call control and media handling;
b. a memory coupled to the said controller for storing the code and data;
c. a PSTN module for handling all PSTN signaling and media;
d. a cordless module for handling wireless connections between handsets and the said base station;
e. a LAN module for handling Internet connections between handsets and the said base station.
f. an end-to-end secured Internet connection with each handset registers at the said base station.

3. The iCord telephone system of claim 1, wherein said one embodiment of the cradle comprises of
a. a controller for mediation between LAN and cordless protocol stacks that facilitate the transport of the call control and media handling messages for voice phone calls;
b. a memory coupled to the said controller for storing the code and data;
c. a cordless module for handling wireless connections between the cradle and handsets;
d. a wired LAN module for handling Internet connection to one or more base stations.

4. The iCord telephone system of claim 1, wherein said one embodiment of the handset comprises of
a. a controller for call control and for media processing and handling for voice phone calls;
b. a memory coupled to the said controller for storing the code and data;
c. a cordless module for handling wireless connection with the base station or the cradle;
d. an end-to-end secured Internet connection with each base station the handset registered with;
e. has a standard cordless handset form factor with a display unit to display information from the iCord base station and select stored phone numbers and other iCord phones registered with the same base station.

5. The system of claim 4, wherein the said handset's cordless module is replaced by a LAN module with wired Internet connectivity with the base stations.

6. The system of claim 4, wherein the said handset's cordless module is replace by a WLAN module with wireless Internet connectivity with the base stations.

7. The iCord telephone system of claim 1 wherein each said base station can have more than one handsets of claim 4 registered with and communicate over the Internet globally, mediated by the said cradle of claim 3.

8. The iCord telephone system of claim 1 wherein each said base station can have more than one handsets of claim 5 registered with and communicate over the Internet globally.

9. The iCord telephone system of claim 1 wherein each said base station can have more than one handsets of claim 6 registered with and communicate over the Internet globally.

10. The system of claim 3 wherein a said cradle can cordlessly communicate with more than one handsets of claim 4, where each said handset connects to one or more base stations.

11. The system of claim 10 wherein a said cradle can impose limit on the said handsets to be allowed to connect to only a selected set of base stations.

12. The system of claim 2 wherein a said base station can incorporate the system of claims 10 and 11 to offer managed mediation service to one or more handsets of claim 4 to connect to other base stations through the said base station.

13. The system of claims 4, 5, 6 wherein the said handset can each registers and communicates with multiple base stations of claim 2.

14. The systems of claim 13 wherein a said handset lets its user select which base station to use for making outgoing phone call.

15. The systems of claim 13 where in a said handset notify its user which base station receives call alert about an incoming phone call.

16. The iCord telephone system of claim 1 where incoming calls to the base station alerts all associated handsets and allow any user to answer the phone.

17. The iCord telephone system of claim 1 where the base station can be configured by the user to recognize caller origin and selectively alerts a subset of iCord phones.

18. The iCord telephone system of claim 1 where an iCord handset user can make a phone call by selecting a name entered into the iCord base station by a user that corresponds to a PSTN number or another iCord phone.

19. The iCord telephone system of claim 1 where the phone call from an iCord handset utilizes the PSTN interface at the base station to make a PSTN call.

20. The iCord telephone system of claim 1 where the phone call from the handset is a VOIP call to another handset associated with a base station that the calling handset has registered with.

21. The iCord telephone system of claim 1, where the user, during a call, can add a third party with a handset associated with a base station that the user's handset has registered with.

22. The iCord telephone system of claim 1 where the iCord base station can have multiple PSTN interfaces allowing multiple simultaneous PSTN calls by different iCord handsets

23. The iCord telephone system of claim 1 where each iCord base station implements end-user programmable station management policies that performs authentication and allows only authenticated and authorized users, handsets to establish the Internet/cordless encrypted connections with the base station.
